(19) United States
(12) Patent Application Publication
(10) Pub. No.: US 2008/0060177 A1
(43) Pub. Date: Mar. 13, 2008

(54) DRESSING TABLE SKIRT

(75) Inventor: MARTY L.R. KOVACS, Chester, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: The Last Quilt Company LLC, Derry, NH (US)

(21) Appl. No.: 11/839,810

(22) Filed: Aug. 16, 2007

Related U.S. Application Data
(60) Provisional application No. 60/839,806, filed on Aug. 24, 2006.

(51) Int. Cl. A47H 23/00; A47G 11/00; A61G 17/00

(52) U.S. Cl. 27/1; 160/330

(57) ABSTRACT

A dressing table skirt and method of manufacture of use are disclosed. An exemplary embodiment of the dressing table skirt may have a tabletop portion with one or more non-skid strips coupled to a first surface of the tabletop portion. The tabletop portion may be sized to fit over a dressing table. The dressing table skirt may also have a skirt portion stitched to a perimeter of the tabletop portion. The skirt portion may also have one or more low skirt fasteners positioned to couple a lower border portion of the skirt portion to the dressing table.

### CROSS-REFERENCE TO RELATED APPLICATIONS

The present application claims priority from U.S. provisional patent application Ser. No. 60/839,806, filed Aug. 24, 2006 entitled Dressing Table Skirt, incorporated by reference herein and for which benefit of the priority date is hereby claimed.

### TECHNICAL FIELD

The present invention relates to viewing products for the funeral industry, and more particularly relates to a dressing table skirt.

### BACKGROUND

It is a basic responsibility of funeral homes to be certain of the identity of a body and prevent mistaken handling of bodies by display the wrong body for visitation or worse cremation of the wrong body. To ensure correct identification of the body many funeral homes and state laws now require that a family member identify the body. For these reasons, personal identification viewings are becoming a common procedure in the funeral home business.

Often the body is placed on a dressing table prior to preparation of the body for viewing or cremation. The personal identification viewing is often viewed as an administrative process and takes place while the body is on the dressing table. Funeral homes are under pressure to provide the service and take loved one's feelings into consideration without adding significant additional costs. The dressing tables are often designed for efficiency in the funeral home preparation process and do not offer a comforting image when viewed by a loved one. The dressing tables are often stainless steel tables on wheels designed for easier cleanup and body preparation by funeral practitioners. It may be disheartening for a family member to see a loved one on a hard steel table. Accordingly there is a need for a dressing table skirt design that conceals the dressing table providing a more pleasing image during the viewing process while providing ease of use by the practitioner. The design may need to provide the ability for efficient handling of the body and ease in positioning of the skirt by the funeral practitioner.

### SUMMARY

The invention features a dressing table skirt; method of manufacture and use are disclosed. An exemplary embodiment of the dressing table skirt may have a tabletop portion with one or more non-skid strips coupled to a first surface of the tabletop portion. The tabletop portion may be sized to fit over a dressing table. The dressing table skirt may also have a skirt portion stitched to a perimeter of the tabletop portion with one or more top skirt fasteners positioned to couple to the edge of a dressing table. The skirt portion may also have one or more low skirt fasteners positioned to couple a lower border portion of the skirt portion to the dressing table.

It is important to note that the present invention is not intended to be limited to a system or method which must satisfy one or more of any stated objects or features of the invention. It is also important to note that the present invention is not limited to the exemplary or primary embodiments described herein. Modifications and substitutions by one of ordinary skill in the art are considered to be within the scope of the present invention, which is not to be limited except by the following claims.

### BRIEF DESCRIPTION OF THE DRAWINGS

These and other features and advantages of the present invention will be better understood by reading the following detailed description, taken together with the drawings wherein:

FIG. 1 is a perspective view of a dressing table skirt 100 according to a first exemplary embodiment of the present invention.

FIG. 2 is a perspective view of a dressing table skirt 200 according to a second exemplary embodiment of the present invention.

FIG. 3 is a top plan view of the dressing table skirt 300 according to a non-slip exemplary embodiment of the present invention.

FIG. 4 is a top plan view of the dressing table skirt 400 according to a slit exemplary embodiment of the present invention.

### DETAILED DESCRIPTION

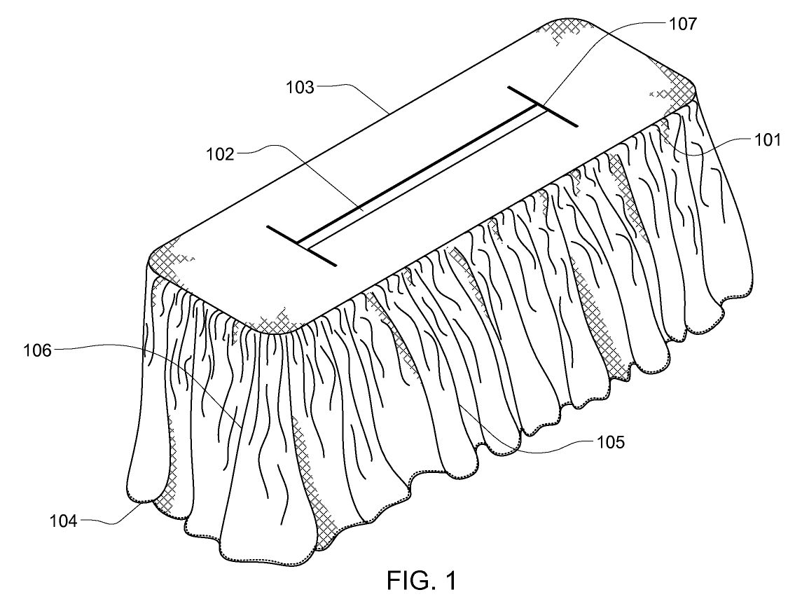

Referring to FIG. 1, a dressing table skirt (DTS) 100 according to a first exemplary embodiment may have a tabletop portion 103 has a seam that couples to a drape portion 105 providing ruffles 101 around the perimeter of the drape portion 105. The bottom edge of the drape portion 105 may have hem 104 around the bottom perimeter. The drape portion 105 borders the perimeter of the tabletop portion 103. The tabletop portion 103 may have an opening 102. The opening 102 allows the dressing table skirt 100 to be position on the dressing table without the need to remove the body from the dressing table. The opening 107 may be only a slit or a slit including side flaps 102, as shown in FIG. 1. The flaps 102 allow the tabletop portion 103 to be tucked under the body after the dressing table skirt 100 is positioned on the dressing table. The tucked in tabletop portion 103 provides the appearance that the dressing table skirt 100 is completely cover the dressing table provided a softer bed like appearance. The sizing and placement of the opening 107 may be designed to allow none or minimal movement of the body to position the dressing table skirt 100 over the around the body. In another exemplary embodiment, the opening 107 may have elastic, ties, or other fasteners to hold the edges of the opening 107 underneath the body once the dressing table skirt 100 is in place.

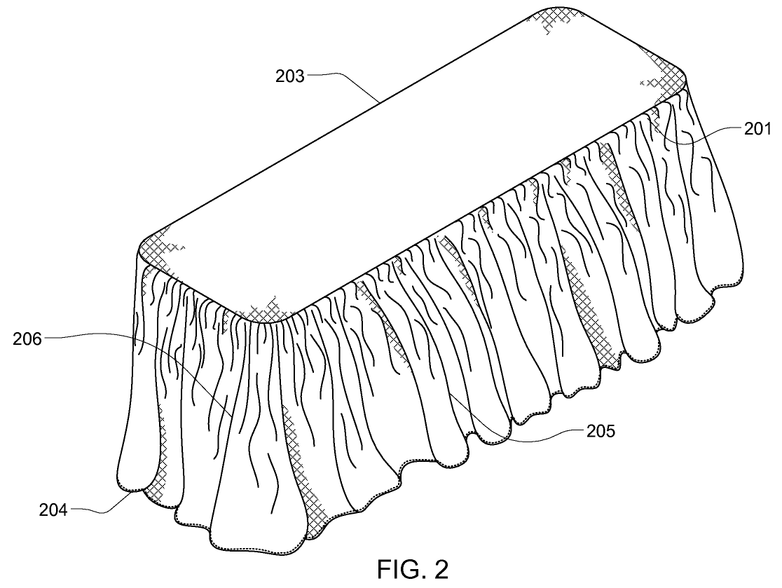

Referring to FIG. 2, a dressing table skirt (DTS) 200 according to a second exemplary embodiment may also have a tabletop portion 203 has a seam that couples to a drape portion 205 providing ruffles 201 around the perimeter of the drape portion 205. The bottom edge of the drape portion 205 may have hem 204 around the bottom perimeter. The drape portion 205 borders the perimeter of the tabletop portion 203. A first set of fasteners couple the edge of the tabletop portion 203 to the dressing table 200. The fasteners may be, for example, but not limited to snaps, hook and loops, magnets, button, adhesive. A second set of fasteners couple the bottom edge of the drape portion 205 to the dressing table. Similarly, the fasteners may be, for example, but not limited to snaps, hook and loops, magnets, button, adhesive. The second set of fasteners may be used to prevent the drape portion 205 from catching the wheels or other objects during movement of the dressing table. A hem 204 may be provided around the bottom perimeter of the drape portion 205. The drape portion 205 may have ruffles or pleats to provide an aesthetically pleasing look to the dressing table skirt.

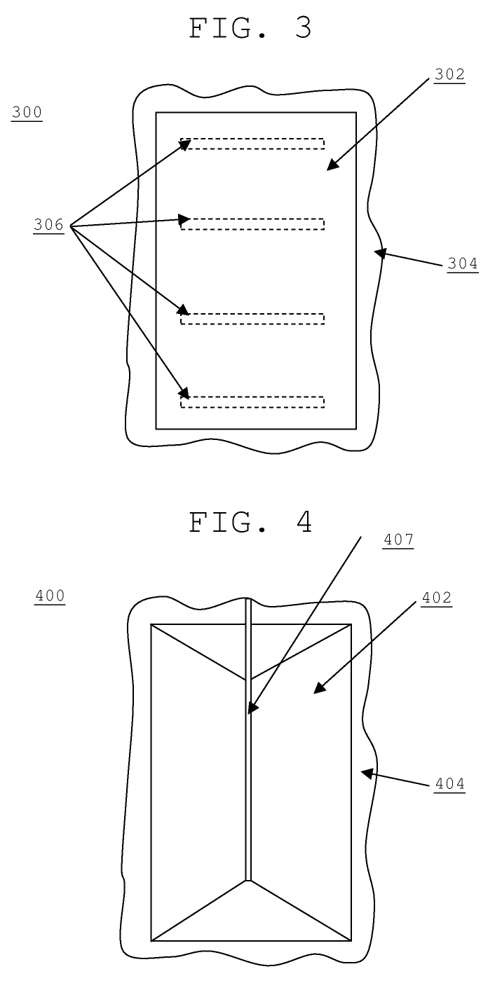

Referring to FIG. 3, a non-slip exemplary embodiment provides a Dressing Table Skirt DTS 300 that prevents a tabletop portion 302 with a drape portion 304 from moving when a body is being positioned on the dressing table. The tabletop portion 302 may have one or more non-skid strip 306 coupled to an under surface of the tabletop portion 302 of the dressing table skirt 300. The non-skid strips may be a variety sizes or shapes. The non-skid strips may be a rubber or adhesive material that grips to the smooth surface of the dressing table.

The non-skid strips 306 play a helpful role in the design and use of the DTS 300. When the body is transferred from the embalming table to the dressing table, it is generally slid across from one surface to the next. The body is also rolled or lifted while on the table during the dressing process. The non-skid strips 306 keep the skirt in place on the table. The skirt needs to stay in place instead of being slid onto the floor during the transfer.

Referring to FIG. 4, a dressing table skirt (DTS) 400 according to a slit exemplary embodiment may have a similar design to the dressing table skirt 100 of the first exemplary embodiment. The tabletop portion 402 with drape portion 404 may have a slit 407. The slit 407 extends almost to an edge of the dress table skirt 400 allowing the dress table skirt 400 to be wrapped around the dressing table. The edges of the slit 407 may be tucked under the body after the dressing table skirt 400 is positioned on the dressing table. The tucked in tabletop portion 402 provides the appearance that the dressing table skirt 400 is completely cover the dressing table. The edges of the slit may also include fasteners to conceal the silt and hold the slit together once position around the body. The slit 407 may be of a length to allow the slit to fit around the torso of a human body without requiring movement of the torso. The slit 407 may also have fasteners or ties to allow the slit or portions of the slit to be coupled together once the dressing table skirt 400 is in place on the dressing table.

The DTS 100, 200, 300, 400 may be placed over a special type of table used at a funeral home. The table may be a mortuary table, for example but not limited to, a dressing table, embalming table, or combination of mortuary table. The DTS may be assembled by hand. The DTS may be sewn on a sewing machine and serger. There may be several stitches involved depending upon the seam needs. The DTS may be sewn to be durable. They may be constructed from the best fabric available to be durable, functional, and disinfectable. The tabletop piece may be cut to fit the size of the dressing table. The non-skid strips can be attached several ways such as stitched or glued. The skirting fabric may be cut for height and hemmed. The top of the fabric to be attached to the tabletop piece can be gathered, pleated, or ruffled. It is then attached to the tabletop piece and double needle serged for durability and strength. The open seam is then finished if the DTS is a partial skirt, or serged together for a 360 degree skirt. The skirt is then inspected for quality and evenness of ruffles

Funeral homes may utilize the DTS for ID views. When a family must come into the funeral home to identify their loved one prior to cremation, many times the body is not in a casket. When the funeral home uses a DTS 100, 200, 300, 400 it covers the piece of equipment called a dressing table. This piece of equipment is narrow, tall and comes in various widths based upon their manufacturer. This piece of furniture may be a certain height, as when the body is done being embalmed; it is moved to this piece of equipment for dressing prior to casketing. Its height is specific to be a comfortable and ergonomic height for funeral directors dressing the body. Most of the tables collapse for easy storage and many of these tables have wheels so the body can be moved from the preparation room to the dressing room to the casketing room, and sometimes into the funeral home chapel. This piece of equipment often is the same for the ID view. To make this identification as comfortable as possible for the family, using the DTS 100 makes it more pleasant and is labor saving, and more sanitary.

Often the funeral home will polish the legs of the dressing table to make it more presentable. This skirt saves the labor and exposure to the chemicals as well as the possibility of ruining one's suit. Funeral Directors do just about everything dressed in a suit never knowing when the phone would ring with a death call, or a family coming in unexpectedly.

The DTS 100, 200, 300, 400 may be made to be easy to use as it may be a one piece unit. It doesn't rely on clips, tape, Velcro or multiple pieces to assemble. The DTS 100, 200, 300, 400 may be machine washable and tumbles dry. The DTS 100, 200, 300, 400 may also be disinfectable by washing with soap and vinegar if necessary in the event that the body has leaked fluids onto the skirt. The skirt can both temporarily hide the leak as well as keep it from spreading by absorbing the liquid. This prevents fluids from leaking onto a solid tabletop that might be touched or seen by a family member, saving the family member from embarrassing or disturbing leakage, which may cause additional pain and suffering.

The DTS 100, 200, 300, 400 can be made from several fabrics, such as cotton, polyester, etc. The fabric is sewn and serged in several places. The DTS 100, 200, 300, 400 may have a piece of fabric that covers the top of the table. Sewn and serged to the tabletop is the skirting. The skirting can be hemmed several ways, such as rolled hem, decorative hem, or hidden hem. The skirting at the top edge where it connects to the tabletop can be ruffled, gathered, elasticized, or pleated. The skirting can go all the way around the furniture, or stop short for just partial coverage. The top of the table may a useful feature for use in the funeral home. Under the fabric, on the surface that touches the table several strips of non-skid material are connected either via sewing or gluing. The narrow ends of the skirt may also have fasteners which allow said skirt ends to be tucked up in order to avoid said skirt ends becoming tangled or caught in the wheels during movement of the table.

The present invention is not intended to be limited to a device or method which must satisfy one or more of any stated or implied object or feature of the invention and is not limited to the exemplary or primary embodiments described herein. Modifications and substitutions by one of ordinary skill in the art are considered to be within the scope of the present invention.

The invention claimed is:

1. A mortuary table skirt comprising:
a tabletop portion sized to fit over a mortuary table wherein the tabletop portion has an aperture sized to fit around a human body and
a drape portion coupled to a perimeter of the tabletop portion.

2. A mortuary table skirt of claim 1, wherein the aperture is a slit running lengthwise.

3. A mortuary table skirt of claim 2, wherein the slit has flaps running parallel to the slit.

4. A mortuary table skirt of claim 1, wherein the drape portion is sized to extend down the sides of the mortuary table to a height shorter than the height of the mortuary table.

5. A mortuary table skirt of claim 1, further comprising one or more top skirt fasteners positioned to couple to an edge of the mortuary table and one or more low skirt fasteners positioned to coupled a lower border portion of the drape portion to the mortuary table.

6. A mortuary table skirt of claim 1, wherein the aperture has fastener for coupling the aperture in a closed position.

7. A mortuary table skirt of claim 1, wherein fabric used to construct the mortuary table skirt is machine washable.

8. A mortuary table skirt of claim 1, wherein fabric used to construct the mortuary table skirt is disinfectable

9. A mortuary table skirt of claim 1, wherein the drape portion includes decorative ruffles.

10. A method of arranging a mortuary table skirt on a mortuary table comprises the actions of:
placing a human body on a mortuary table;
positioning an aperture of a tabletop portion of a mortuary table skirt around the human body on the mortuary table;
positioning the tabletop portion on top of a mortuary table skirt on a table portion of the mortuary table; and
positioning a drape portion of the mortuary table skirt around sides of the mortuary table.

11. A method of arranging a mortuary table skirt of claim 10 further comprising the action of:
tucking edges of the aperture of the tabletop portion underneath the human body.

12. A method of arranging a mortuary table skirt of claim 10 further comprising the action of:
coupling fasteners to hold the mortuary table skirt to the mortuary table.

13. A method of arranging a mortuary table skirt of claim 10 further comprising the action of:
providing an identification viewing of the human body

14. A method of arranging a mortuary table skirt of claim 13 further comprising the action of:
removing the mortuary table skirt by positioning an aperture of a tabletop portion of a mortuary table skirt around the human body on the mortuary table and removing the mortuary table skirt from the mortuary table.

15. A dressing table skirt comprising:
a tabletop portion having one or more non-skid strips coupled to a first surface of the tabletop portion sized to fit over a dressing table and
a drape portion coupled to a perimeter of the tabletop portion.

16. A dressing table skirt of claim 15, wherein the drape portion has one or more top skirt fasteners positioned to couple to the edge of a dressing table and one or more low skirt fasteners positioned to coupled a lower border portion of the drape portion to the dressing table.

17. A dressing table skirt of claim 15, wherein a slit extends from the tabletop portion down the drape portion providing a U-shaped mortuary table skirt.

18. A dressing table skirt of claim 15, wherein the slit is sized to fit around a torso of the human body.

19. A dressing table skirt of claim 15, further comprising one or more top skirt fasteners positioned to couple to the edge of a dressing table and one or more low skirt fasteners positioned to coupled a lower border portion of the drape portion to the dressing table.

20. A dressing table skirt of claim 15, wherein the tabletop portion has an aperture sized to fit around a human body.
